(19) United States
(12) Patent Application Publication
(10) Pub. No.: US 2010/0255951 A1
(43) Pub. Date: Oct. 7, 2010

(54) Intermittent Drive Systems

(75) Inventors: Phineas Alexander Levy, Kent (GB); Ruzena Levy, Kent (GB); Michael Webb, Hampshire (GB)

Correspondence Address: BARNES & THORNBURG LLP, P.O. BOX 2786, CHICAGO, IL, 60690-2786, US

(73) Assignee: Oakland Business Centre, Berkshire (GB)

(21) Appl. No.: 11/908,382

(22) PCT Filed: Mar. 13, 2005
(86) PCT No.: PCT/EP06/60670

§ 371 Date: Jul. 10, 2008

(30) Foreign Application Priority Data
Mar. 11, 2005 (GB) 0505010.9

(51) Int. Cl. F16H 57/08; B65H 5/06; B65H 29/20; B65H 45/16; B65H 45/28; B26D 1/34; B41L 47/14

(52) U.S. Cl. 475/331; 271/3.14; 493/353; 493/426; 101/477

(57) ABSTRACT

To fold sheets of newsprint (1), a ring gear 7 is driven in rotation by a motor 11 under the control of a controller 12 such that, for most of the time, the ring gear 7 rotates at the same speed as a folding cylinder 2 and arms 8. When it is desired to initiate a folding operation, the ring gear 7 is momentarily stopped or slowed. The relative motion that occurs between the ring gear 7 and planet gears on the arms 8 causes the planet gears 9 to rotate about their axes and respective tucking blades 6 mounted on the planet gears 9 to protrude above the surface of the cylinder 2, where they engage collated sheets on the cylinder surface and push them into the nip of folding rollers (4). Upon completion of the movement of the planet gears 9 and associated tucking blades 6, the ring gear 7 is again caused to move at the same angular speed as the arms 8, such that the tucking blades 6 retain their “silenced” positions below the surface of the cylinder 2.

The present invention relates to intermittent drive systems and is concerned particularly, although not exclusively, with intermittent drive systems for tucking blades that are used for cutting, collating and folding sheets in, for example, the newspaper printing industry.

In a conventional newspaper printing press, a plurality of webs of printed paper are fed to a cutting and folding station, where they are cut and entrained in layers on a folding cylinder. As the folding cylinder rotates, a tucking blade is caused to protrude from the cylinder at a predetermined angular position of the cylinder, where the blade engages the layers of printed paper on the surface of the cylinder and pushes them into the nip of a folding roller assembly, where the sheets of paper are folded and then passed on to subsequent stations for further possessing.

In such a conventional arrangement, the tucking blade is activated at the same angular position, upon each revolution of the cylinder. In practice, a number of tucking blades may be provided at regular intervals around the folding cylinder, for faster operation.

Such a conventional arrangement is unsuitable for modern digital printing presses. One reason is that, with digital presses, the page content is varied serially along the web of newsprint (paper), rather than combining a plurality of webs that are printed identically along each web and shifted in phase. In a digital arrangement, when the web is cut, successive sheets have to be collated on the folding cylinder, before they can be folded. In consequence, it is necessary to operate the tucking blade only intermittently, rather than invariably upon each revolution of the folding cylinder.

There is thus a requirement for an intermittent drive mechanism to operate a tucking blade on a folding cylinder, in a manner compatible with collation, cutting and folding of a printed web from a digital printing press. Moreover, it is desirable for such a mechanism to be capable of operating at the very high throughput speeds of which modern digital printing presses are capable.

Typically, in a digital printing press, printing is effected by digital means using a rotating drum onto which an electronic image is imposed by an electrostatic charge. This in turn attracts a toner powder, or liquid, which is deposited on the web of paper. Using an electrostatic discharge device, the image on the drum is removed ready to receive a fresh image, thereby giving sequential pagination as the web of paper passes through the printing press. Drum diameter has no relationship to the print length.

Preferred embodiments of the invention aim to provide an intermittent drive mechanism that meet such requirements.

According to one aspect of the present invention, there is provided a sheet handling system comprising:
a. a cylinder arranged to engage a sheet on the outer circumferential surface of the cylinder and to transport the sheet from an entry position to an exit position by rotation of the cylinder about its axis; and
b. a drive mechanism mounted at least partly within the cylinder and arranged to cause a member to protrude intermittently from the surface of the cylinder to engage a sheet on that surface:
c. said drive mechanism comprising:
   i. a primary gear mounted for rotation about an axis parallel to the cylinder axis;
   ii. an arm extending radially of the cylinder and mounted for rotation about an axis parallel to the cylinder axis; and
   iii. a planet gear mounted for rotation on said arm, in driving engagement with said primary gear, and operatively connected to said member:

wherein:
d. said primary gear is arranged to rotate according to a first velocity profile;
e. said arm is arranged to rotate according to a second velocity profile; and
f. said first and second velocity profiles are such that:
   i. said planet gear rotates to cause said member to protrude from the surface of the cylinder at first selected times when the cylinder is in a given angular position; and
   ii. said planet gear does not rotate to cause said member to protrude from the surface of the cylinder at second selected times when the cylinder is in said given angular position.

Preferably, said primary gear is mounted for rotation about the cylinder axis.

Preferably, said arm is mounted for rotation about the cylinder axis.

The said member may be a tucking blade that cooperates with a folding nip to fold said sheet.

The said member may be a cutting blade.

The said member may be a numbering head.

Preferably, said primary gear is a sun gear.

Said primary gear may be a ring gear.

A sheet handling system as above may further comprise a motor arranged to drive said primary gear in rotation.

A sheet handling system as above may further comprise a motor arranged to drive said arm in rotation.

Preferably, said arm is fixed relative to the cylinder such that the arm rotates with the cylinder.

Said primary gear may be fixed relative to the cylinder such that the arm rotates with the cylinder.

A sheet handling system as above may further comprise control means arranged to determine said first and/or second velocity profile.

Preferably, said control means is arranged to control movement of at least one electric motor arranged to drive said primary gear and/or arm and/or cylinder in rotation.

Preferably, a sheet handling system as above further comprises retaining means arranged to retain one or more sheet on the cylinder.

Preferably, a sheet handling system as above further comprises means arranged to engage and release said retaining means at times fixed in relation to operation of said member.

Preferably, a sheet handling system as above further comprises cutting means arranged to cut a web of material into sheets as it is fed onto the cylinder.

Preferably, a sheet handling system as above comprises a plurality of planet gears mounted for rotation on respective arms of a planet carrier and in driving engagement with said primary gear:

A sheet handling system as above may comprise a plurality of members arranged to protrude intermittently from the surface of the cylinder to engage a sheet on that surface.

Preferably, each said planet gear is operatively connected to a respective one of said members.

A sheet handling system as above may further comprise guide means arranged to constrain movement of said planet gear when said cylinder is in said given angular position.

Preferably, said guide means is such as to constrain movement such that said planet gear may occupy only two possible angular positions when said cylinder is in said given angular position.

In another aspect, the invention provides a printing press incorporating a sheet handling system according to any of the preceding aspects of the invention, arranged to cut and/or collate and/or fold printed sheets of newsprint.

Such a printing press may be arranged to feed a single web of printed newsprint onto the cylinder, where the web is cut, collated and folded.

Printing may be effected by a digital process.

In another aspect, the invention provides an intermittent drive system comprising:
a. a cylinder mounted for rotation about its axis; and
b. a drive mechanism mounted at least partly within the cylinder and arranged to cause a member to protrude intermittently from the surface of the cylinder:
c. said drive mechanism comprising:
   i. a primary gear mounted for rotation about an axis parallel to the cylinder axis;
   ii. an arm extending radially of the cylinder and mounted for rotation about an axis parallel to the cylinder axis; and
   iii. a planet gear mounted for rotation on said arm, in driving engagement with said primary gear, and operatively connected to said member:

wherein:
d. said primary gear is arranged to rotate according to a first velocity profile;
e. said arm is arranged to rotate according to a second velocity profile; and
f. said first and second velocity profiles are such that:
   i. said planet gear rotates to cause said member to protrude from the surface of the cylinder at first selected times when the cylinder is in a given angular position; and
   ii. said planet gear does not rotate to cause said member to protrude from the surface of the cylinder at second selected times when the cylinder is in said given angular position.

Such an intermittent drive system may optionally include any of the further features described or illustrated herein.

For a better understanding of the invention, and to show how embodiments of the same may be carried into effect, reference will now be made, by way of example, to the accompanying diagrammatic drawings, in which:

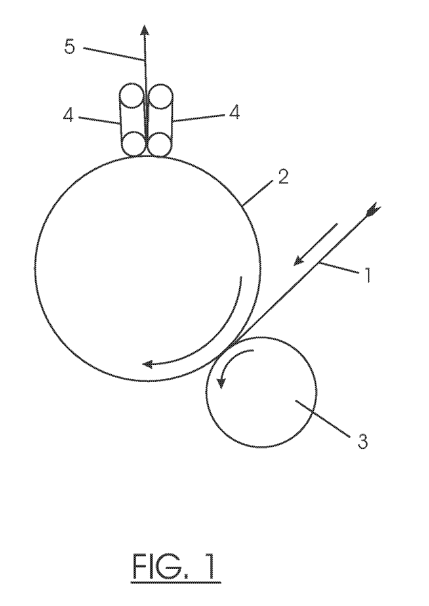

FIG. 1 illustrates a cutting and folding station in a printing press;

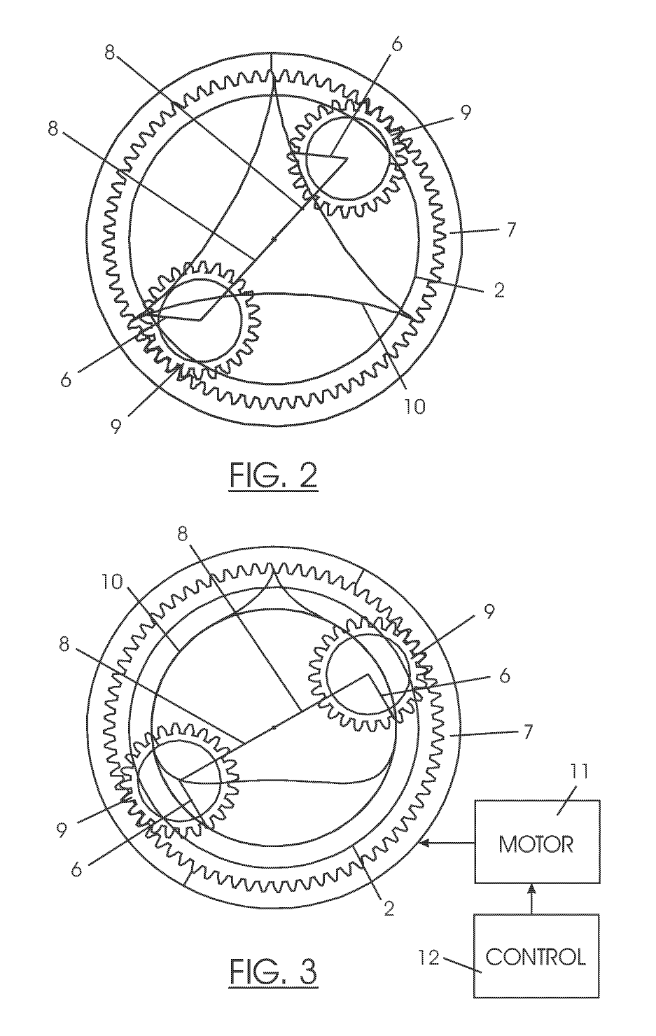

FIG. 2 illustrates a conventional tucking blade drive arrangement;

FIG. 3 is a view similar to that of FIG. 2, but illustrating an improved tucking blade drive arrangement; and

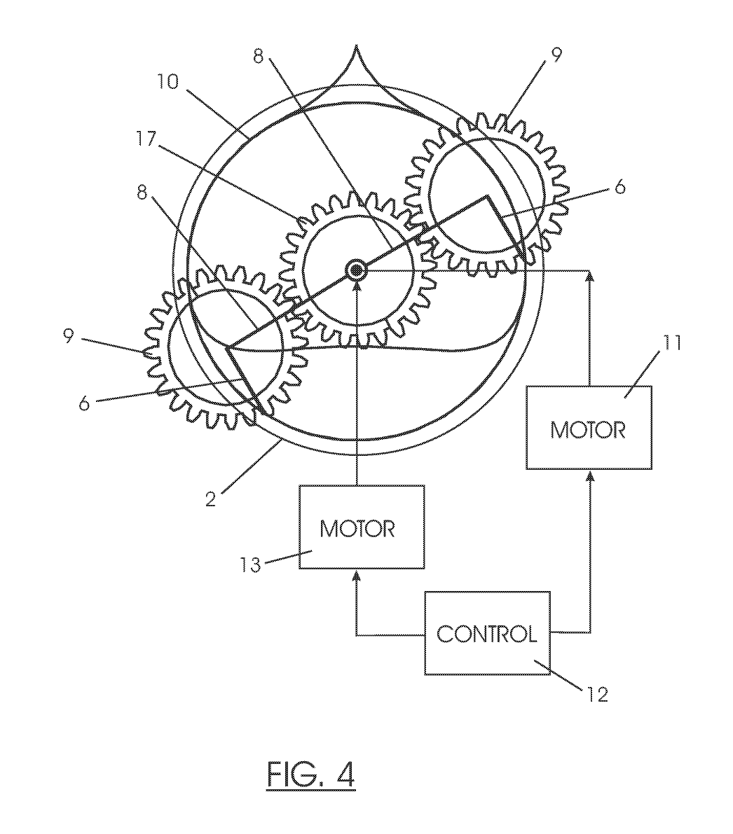

FIG. 4 is another view similar to that of FIG. 2, but illustrating another improved tucking blade drive arrangement

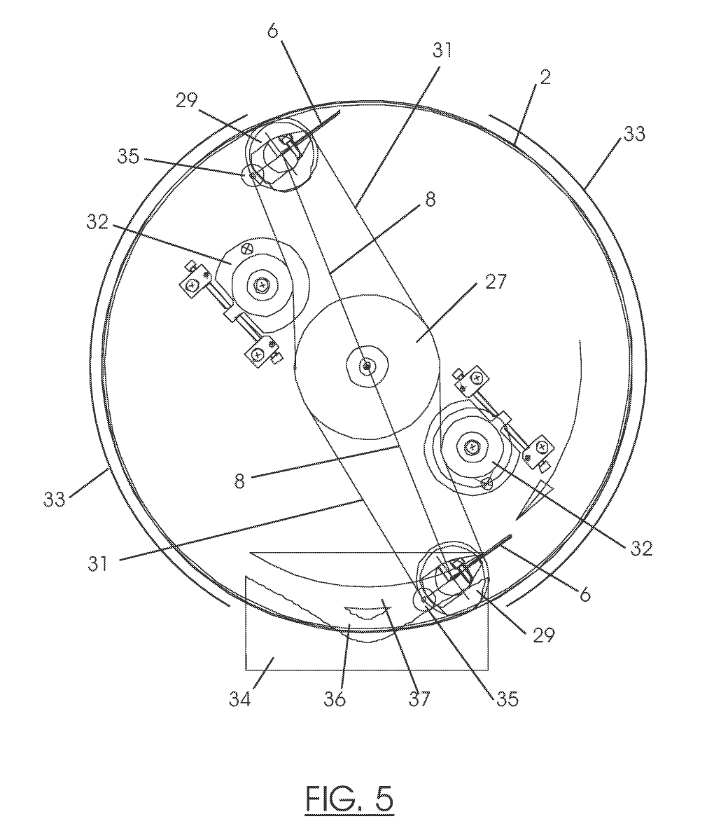

FIG. 5 is another view similar to that of FIGS. 2 and 3, but illustrating an alternative embodiment.

In the figures, like references denote like or corresponding parts.

In FIG. 1, a web 1 of printed newsprint is fed to a nip between a folding cylinder 2 and a cutting cylinder 3. The folding cylinder 2 carries a row of needles (not shown, but well known to the skilled reader) and the cutting cylinder 3 is provided with a serrated knife (not shown, but equally well known to the skilled reader).

The leading edge of the web 1 is impaled on the row of needles carried on the folding cylinder 2, a small distance (e.g. 15 mm) back from what will be the cut. At about the same time as the needles pierce the paper, the serrated knife mounted across the cutting cylinder 3 severs the web 1, leaving the leading edge of the web impaled on the needles, ready to be carried around by the rotating folding cylinder 2.

Mounted above and close to the top of the folding cylinder 2 is a pair of folding rollers 4 providing a nip into which cut sheets carried on the folding cylinder 2 are inserted, to make a fold. The aforementioned tucking blade is usually retained below the outer surface of the cylinder 2. However, by way of a gearing mechanism, the tucking blade is arranged to project above the surface of the cylinder 2 as it approaches the folding rollers 4, thereby to engage the sheet of cut paper on the surface of the cylinder 2 and push it into the nip of the folding rollers 4, which then transport the paper upwardly as shown at 5 and thereby complete the fold.

This general mode of operation, as explained thus far, may be common to both conventional folding and cutting stations and to embodiments of the present invention.

In a conventional system, with traditional printing presses, instead of a single web 1, a plurality of identical webs are fed into the nip of the folding and cutting cylinders 2, 3 in suitable phase relationship, to make up a complete newspaper. The layered sheets of paper are cut together on the cutting cylinder 3 and travel around the folding cylinder 2, on which they are impaled by the aforementioned needles, until the tucking blade operates adjacent the nip of the folding rollers 4, to fold all of the sheets together and feed the folded sheets together upwardly as shown at 5.

As a point of detail, the folding rollers 4 would typically be found below the folding cylinder 2 in a conventional arrangement. However, in preferred embodiments of the present invention, they are provided at the top of the folding cylinder 2, as other operations, not common to normal newspaper production, are required.

FIG. 2 illustrates in further detail the tucking blade 6 of a conventional system. In the example of FIG. 2, two complementary tucking blades 6 are provided at diametrically opposite positions with respect to the folding cylinder 2. In FIG. 2, the folding cylinder 2 is represented by its external diameter. A stationary ring gear 7 is disposed coaxially around the folding cylinder 2.

A planet carrier having diametrically opposite arms 8 is mounted in fixed relation to the folding cylinder 2 and is arranged to rotate coaxially with it. Each arm 8 carries at its end a respective planet gear 9, which meshes with internal teeth of the ring gear 7 and is arranged to rotate freely on the arm 8.

Each tucking blade 6 is fixed in relation to a respective planet gear 9, such that it rotates with it. The resulting locus of travel of each of the tucking blades 6 is shown at 10. It can be seen from this that each tucking blade 6 protrudes from the surface of the folding cylinder 2 at three equally-spaced) (120°)angular positions of the rotating cylinder.

With a general configuration as illustrated in FIG. 1, when each tucking blade 6 protrudes from the surface of the folding cylinder 2 at the uppermost angular position of the rotating cylinder, it pushes the cut sheets of paper on the surface of the cylinder 2 into the nip of the folding rollers 4. In a conventional arrangement, the cut sheets are present on only about half of the cylinder surface, such that the tucking blades 6 do not engage the cut sheets in the two lower (as seen in FIG. 2) positions where they protrude from the cylinder 2.

The conventional arrangement as illustrated and described with reference to FIGS. 1 and 2 works very well with traditional printing presses. The geared configuration assures reliable, high-speed operation, in synchronisation with the rest of the printing press. The provision of two tucking blades 6 facilitates a high throughput rate. Each of the two tucking blades 6 co-operates in turn with the folding rollers 4, during each revolution of the cylinder 2.

However, as described above, this arrangement becomes unsuitable when the web 1 that is fed to the folding and cutting cylinders 2, 3 is provided from a digital printing press. In this case, the folding cylinder 2 needs to perform several revolutions, during each of which a successive sheet of the web 1 is cut and collated on the folding cylinder 2 with the other sheets necessary to make up the respective publication, prior to initiating a folding operation. Thus, the tucking blades 6 need to be kept below the surface of the folding cylinder 2 until they are required to be activated, once every x revolutions, where x is an integer equal to 2 or more.

After considerable thought, we have come up with a modification of the configuration shown in FIG. 2, to provide a relatively simple and reliable means of activating tucking blades 6 intermittently.

Such an arrangement is shown in FIG. 3, where corresponding parts carry the same references as in FIG. 2.

The principle difference between the arrangements of FIGS. 2 and 3 is that, in FIG. 3, the ring gear 7 is not stationary but driven in rotation by a motor 11 under the control of a controller 12.

The controller 12 controls operation of the motor 11 such that, for most of the time, the ring gear 7 rotates at the same speed as the cylinder 2 and arms 8. However, when it is desired to initiate a folding operation, the ring gear 7 is momentarily stopped or slowed. The relative motion that then occurs between the ring gear 7 and the planet gears 9 causes the planet gears 9 to rotate about their axes and cause the respective tucking blades 6 to protrude above the surface of the folding cylinder 2, where they can engage the collated sheets on the cylinder surface and push them into the nip of the folding rollers 4. Upon completion of the movement of the planet gears 9 and associated tucking blades 6, the ring gear 7 is again caused to move at the same angular speed as the arms 8, such that the tucking blades 6 retain their “silenced” positions, below the surface of the cylinder 2.

It will be appreciated that, by modern motor control techniques, the movement of the ring gear 7 can be controlled very precisely, and it may be given any desired velocity profile. Preferably, the ring gear is servo driven. Synchronisation of the ring gear 7 with the planet arms 8 and cylinder 10 may be effected in many suitable ways—for example, the ring gear 7 and folding cylinder 2 may be optically coded to facilitate synchronisation.

One possible locus of a tucking blade 6 is shown in FIG. 3 by the reference 10. As will be understood from the above, any other suitable locus may be obtained, with a view to providing rapid and reliable operation of the tucking blade 6 with a motion that is as smooth and gentle as possible.

It is of course necessary to activate the retaining needles on the folding cylinder 2, in synchronism with a folding operation. Conveniently, the needles may be driven by cam operated from the shafts of the planet gears 9, to cause the needles to retract at the appropriate time to enable a folding operation to take place, and subsequently to project again from the cylinder surface.

FIG. 4 shows an arrangement which is similar to that of FIG. 3, but in which the driven ring gear 7 is replaced by a driven sun gear 17. In FIG. 4, the sun gear 7 is driven by the motor 11 under control of the controller 12, so as to have a velocity profile that gives rise to a locus 10 of the tucking blades 6 that is similar to that shown in FIG. 3. As will be understood from the foregoing description, any other desired locus may be achieved by appropriate control of the motor 11. A particular advantage of the arrangement shown in FIG. 4 is that, because the sun gear 17 is much smaller than the ring gear 7, the overall inertia of the system driven by the motor 11 can be very significantly less, thereby facilitating smooth and accurate control of the respective velocity profile.

In FIG. 4, there is also shown a further motor 13 that drives both the planet carrier arms 8 and the folding cylinder 2 in rotation, under control of the controller 12. If desired, the cylinder 2 may be driven by a further motor under separate control, such that the velocity profiles of the outputs of the respective motors and the systems that they drive can all be controlled independently, in line with the velocity profile of the digital printing press.

In FIG. 4, the sun gear 17 is shown as being in direct engagement with the planetary gears 9. However, it is possible for the sun (or ring) and planet gears to be in driving engagement via intermediate gears which, for the purposes of this specification, includes toothed or tooth-engaging driving belts, and in the context of this specification, the term “driving engagement” is to be construed accordingly.

FIG. 5 shows an alternative arrangement in which a centre sprocket or pulley 27 is driven with a desired velocity profile by a variable speed motor (servo motor) and is equivalent to the sun wheel 17 in FIG. 4. The centre sprocket or pulley 27 drives a pair of circumferentially mounted sprockets or pulleys 29 to which it is connected by one or more chain or belt 31. The sprockets or pulleys 29 are equivalent to the planet gears 9 in the previous embodiments. This arrangement results in a lower rotary inertia as compared to either the ring gear or the sun gear arrangements as previously described. Tensioning devices 32 keep the or each chain or belt 31 under suitable tension. The general mode of operation of the embodiment of FIG. 5 may be readily understood from the description of the previous embodiments.

The tucking blades 6 in FIG. 5 may now be coupled to the motion of the cylinder 2 only through electronic control. If this coupling or synchronisation were to fail whilst the machine is running, then it is possible that a tucking blade 6 may start to emerge from the cylinder 2. For most of the revolution of the cylinder 2, a guard cage 33 mounted around the circumference of the collecting cylinder 2 and its collated newspaper sheets would restrain the tucking blade 6 whilst the cylinder 2 decelerates to a stop. In this respect, it will be appreciated that the collated newspaper sheets would be forced into the gap between cylinder 2 and cage 33 and act as a very effective friction brake. The only time this would not happen is if the tucking blade 6 starts to emerge in the vicinity of the folding rolls.

To overcome this potential problem, a cam-track device 34 is provided at either the folding tucking blade position in the vicinity of the folding rolls or, as shown in FIG. 5, in the vicinity of another non-folding tucking blade 6 whilst the folding blade 6 is in the vicinity of the folding rolls. This latter arrangement is useful where there is less room available in the vicinity of the folding rolls. The cam-track device 34 provides two cam-tracks 36 and 37 along which travel cam followers 35 that are attached to and rotate with each of the sprocket or pulleys 29. The cam-track 36 prevents the tucking blade 6 from emerging if it hasn't already started to do whilst, if the blade 6 has started to emerge, then the cam-track 37 forces it to emerge correctly, even if it is not driven properly by the servo motor via sprocket or pulley 27. With the cam-track device placed to guide one of the non-folding tucking blade mechanisms, the chain or belt drive mechanism is used to force the folding tucking blade 6 to move correspondingly.

Although tucking blades 6 are shown in the illustrated embodiments as being driven together, any number of tucking blades can alternatively be driven individually.

The arrangement of FIG. 3 may optionally include an idling sun gear and that of FIG. 4 may optionally include an idling ring gear.

Although the intermittent drive mechanisms illustrated and described above are shown as controlling movement of tucking blades 6, they may be adapted or modified to drive other members in an intermittent manner. For example, they may control intermittent movement of cutting blades or numbering heads (devices arranged to print consecutive numbers on consecutive prints).

Intermittent drive mechanisms that are the subject of the present invention may be employed in alternative ways—e.g. for bending or forming wire in the wire forming industry. Although the illustrated use is with a paper web 1, folding, cutting or other operations may be performed on webs of other materials, such as cloth, wood and metals. Due to the high degree of control afforded by the intermittent drive mechanisms, webs of material may be cut either into set lengths or differing lengths.

In this specification, the verb “comprise” has its normal dictionary meaning, to denote non-exclusive inclusion. That is, use of the word “comprise” (or any of its derivatives) to include one feature or more, does not exclude the possibility of also including further features.

The reader's attention is directed to all and any priority documents identified in connection with this application and to all and any papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A sheet handling system comprising:
a. a cylinder arranged to engage a sheet on the outer circumferential surface of the cylinder and to transport the sheet from an entry position to an exit position by rotation of the cylinder about its axis; and
b. a drive mechanism mounted at least partly within the cylinder and arranged to cause a member to protrude intermittently from the surface of the cylinder to engage a sheet on that surface:
c. said drive mechanism comprising:
i. a primary gear mounted for rotation about an axis parallel to the cylinder axis;
ii. an arm extending radially of the cylinder and mounted for rotation about an axis parallel to the cylinder axis; and
iii. a planet gear mounted for rotation on said arm, in driving engagement with said primary gear, and operatively connected to said member: wherein:
d. said primary gear is arranged to rotate according to a first velocity profile;
e. said arm is arranged to rotate according to a second velocity profile; and
f. said first and second velocity profiles are such that:
i. said planet gear rotates to cause said member to protrude from the surface of the cylinder at first selected times when the cylinder is in a given angular position; and
ii. said planet gear does not rotate to cause said member to protrude from the surface of the cylinder at second selected times when the cylinder is in said given angular position.

2. A sheet handling system according to claim 1, wherein said primary gear is mounted for rotation about the cylinder axis.

3. A sheet handling system according to claim 1, wherein said arm is mounted for rotation about the cylinder axis.

4. A sheet handling system according to claim 1, wherein said member is a tucking blade that cooperates with a folding nip to fold said sheet.

5. A sheet handling system according to claim 1, wherein said member is a cutting blade.

6. A sheet handling system according to claim 1, wherein said member is a numbering head.

7. A sheet handling system according to claim 1, wherein said primary gear is a sun gear.

8. A sheet handling system according to claim 1, wherein said primary gear is a ring gear.

9. A sheet handling system according to claim 1, further comprising a motor arranged to drive said primary gear in rotation.

10. A sheet handling system according to claim 1, further comprising a motor arranged to drive said arm in rotation.

11. A sheet handling system according to claim 1, wherein said arm is fixed relative to the cylinder such that the arm rotates with the cylinder.

12. A sheet handling system according to claim 1, wherein said primary gear is fixed relative to the cylinder such that the arm rotates with the cylinder.

13. A sheet handling system according to claim 1, further comprising control means arranged to determine said first and/or second velocity profile.

14. A sheet handling system according to claim 13, wherein said control means is arranged to control movement of at least one electric motor arranged to drive said primary gear and/or arm and/or cylinder in rotation.

15. A sheet handling system according to claim 1, further comprising retaining means arranged to retain one or more sheet on the cylinder.

16. A sheet handling system according to claim 15, further comprising means arranged to engage and release said retaining means at times fixed in relation to operation of said member.

17. A sheet handling system according to claim 1, further comprising cutting means arranged to cut a web of material into sheets as it is fed onto the cylinder.

18. A sheet handling system according to claim 1, comprising a plurality of planet gears mounted for rotation on respective arms of a planet carrier and in driving engagement with said primary gear:

19. A sheet handling system according to claim 1, comprising a plurality of members arranged to protrude intermittently from the surface of the cylinder to engage a sheet on that surface.

20. A sheet handling system according to claims 18, wherein each said planet gear is operatively connected to a respective one of said members.

21. A sheet handling system according to claim 1, further comprising guide means arranged to constrain movement of said planet gear when said cylinder is in said given angular position.

22. A sheet handling system according to claim 21, wherein said guide means is such as to constrain movement such that said planet gear may occupy only two possible angular positions when said cylinder is in said given angular position.

23. (canceled)

24. A printing press incorporating a sheet handling system according to claim 1, arranged to cut and/or collate and/or fold printed sheets of newsprint.

25. A printing press according to claim 24, arranged to feed a single web of printed newsprint onto the cylinder, where the web is cut, collated and folded.

26. A printing press according to claim 25, wherein printing is effected by a digital process.

27. (canceled)

28. (canceled)

29. (canceled)

30. An intermittent drive system comprising:
a. a cylinder mounted for rotation about its axis; and
b. a drive mechanism mounted at least partly within the cylinder and arranged to cause a member to protrude intermittently from the surface of the cylinder:
c. said drive mechanism comprising:
i. a primary gear mounted for rotation about an axis parallel to the cylinder axis;
ii. an arm extending radially of the cylinder and mounted for rotation about an axis parallel to the cylinder axis; and
iii. a planet gear mounted for rotation on said arm, in driving engagement with said primary gear, and operatively connected to said member: wherein:
d. said primary gear is arranged to rotate according to a first velocity profile;
e. said arm is arranged to rotate according to a second velocity profile; and
f. said first and second velocity profiles are such that:
i. said planet gear rotates to cause said member to protrude from the surface of the cylinder at first selected times when the cylinder is in a given angular position; and
ii. said planet gear does not rotate to cause said member to protrude from the surface of the cylinder at second selected times when the cylinder is in said given angular position.

31. (canceled)

32. (canceled)
